(19) United States
(12) Patent Application Publication
(10) Pub. No.: US 2015/0203025 A1
(43) Pub. Date: Jul. 23, 2015

(54) Reverse Light Assembly for Tractor-Trailers

(71) Applicant: Peter Harmon, China Grove, NC (US)

(72) Inventor: Peter Harmon, China Grove, NC (US)

(21) Appl. No.: 14/547,847

(22) Filed: Nov. 19, 2014

Related U.S. Application Data
(60) Provisional application No. 61/906,075, filed on Nov. 19, 2013.

(51) Int. Cl. B60Q 1/22

(52) U.S. Cl. CPC B60Q 1/22; B60Q 2900/30

(57) ABSTRACT

A reverse light assembly that is mountable on the rear of the trailer portion of a tractor-trailer or similar vehicle. The reverse light assembly comprises a reverse light housing removably or permanently securable to the rear of a trailer by means of brackets and fasteners, such as screws, or bolts, among others. The reverse light housing includes one or more lights thereon to provide illumination in the rear of the vehicle and illuminates to indicate that the tractor-trailer is in reverse. The reverse light housing may be remotely operated by a control unit inside of the cabin of the vehicle or by a key fob device so that the user can selectively illuminate the lights thereon. Alternatively, the reverse light assembly may be operably connected to the vehicle's electrical system so as to allow the lights to automatically illuminate when the tractor-trailer is shifted into reverse.

### CROSS REFERENCE TO RELATED APPLICATION

This application claims the benefit of U.S. Provisional Application No. 61/906,075 filed on Nov. 19, 2013. The above identified patent application is herein incorporated by reference in its entirety to provide continuity of disclosure.

### BACKGROUND OF THE INVENTION

1. Field of the Invention

The present invention relates to a reverse light assembly for illuminating the rear of a tractor-trailer or other similar vehicle when the vehicle is in reverse in order to alert other drivers and pedestrians. The reverse light assembly may be operated by a control unit in the cabin of the vehicle, or the light assembly may be operably connected to a vehicle's reverse lights so that the reverse light assembly illuminates automatically when the vehicle is shifted into reverse.

Many accidents involving tractor-trailers occur when the vehicle is moving in reverse. The driver of a tractor-trailer may have a difficult time seeing objects behind or on the sides of the vehicle, creating a risk that the tractor-trailer will collide with another vehicle or object. The driver may have further difficulty when reversing in low light conditions or during periods of inclement weather. The driver must use his rear-view mirrors in order to determine if objects are behind the vehicle, however the mirrors do not provide full visibility of the rear of the vehicle. Moreover, while the tractor portion of tractor-trailers includes reverse lights, not all trailers include reverse lights thereon. Thus, a vehicle behind the trailer may not be aware that the tractor-trailer is about to move in reverse since no signals are provided on the rear of the trailer.

Thus, the present invention provides a reverse light assembly for tractor-trailers. The reverse light assembly is adapted to be mounted on a rear portion of the trailer of a tractor-trailer such that the lights are rearward facing. The reverse light assembly can be remotely operated by means of a control unit. In such embodiments, the reverse light housing includes a wireless signal receiving device for receiving a signal from a wireless signal transmitting device within the control unit. The user can activate the control unit to illuminate the lights when the vehicle is in reverse. In alternate embodiments, the reverse light assembly is operably connected to the reverse lights of the tractor portion of the tractor-trailer so that the reverse lights on the trailer illuminate when the vehicle is in reverse.

2. Description of the Prior Art

Devices have been disclosed in the prior art that relate to vehicle light assemblies. These include devices that have been patented and published in patent application publications. These devices generally relate to vehicle light assemblies for illuminating the rear of tractor-trailers. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 6,422,728 to Riggin discloses a safety light for a vehicle. The safety light comprises a housing mountable to the rear portion of a vehicle and includes a light source that projects a visual line or reference from the housing onto the roadway. The visual line extends perpendicular to the direction of travel of the vehicle, and allows a driver to determine the position of obstacles relative to the rear end of the vehicle. Thus, Riggin relates to a lighting device for projecting light towards the sides of the vehicle, and does not include a reverse light controllable by a user and that is rearward-facing.

Another device, U.S. Pat. No. 5,209,559 to Ruppel discloses a trailer light system that helps drivers to observe obstacles at the rear of the vehicle. The device illuminates the rear wheels and areas adjacent to the wheels. The light system includes a light assembly mounted under a vehicle body above the rear wheels such that light is directed downward and outward in relation to the vehicle body. Thus, Ruppel discloses a light system to illuminate the vehicle wheels and areas adjacent thereto and does not provide a reverse light system that is remotely controlled by the driver of the vehicle or that is operably connected to the vehicle's existing reverse lights.

U.S. Pat. No. 5,682,138 to Powell et al. discloses an illumination system for the rear wheel assembly of a vehicle. The illumination system activates for a predetermined period of time when a turn signal is activated. The system includes an auxiliary light on the underside of a semi-trailer and is adapted to illuminate when the vehicle's lights are on and when the turn signal on the appropriate side of the vehicle is activated. Powell et al. does not disclose a light assembly to be positioned on the rear of a tractor-trailer and that illuminates when the tractor-trailer is moving in reverse in order to illuminate the rear of the vehicle and alert others in the nearby area.

U.S. Pat. No. 7,868,555 to Peron et al. discloses a vehicle light system. The system comprises a series of lights arranged in a row that are activated sequentially when a particular event occurs. The system is adapted for connection to a vehicle's signal system and power source. Thus, Peron et al. does not relate to a reverse light assembly for the rear of a tractor-trailer that indicates when the vehicle is in reverse and that can be remotely operated by a user.

Finally, U.S. Pat. No. 5,430,625 to Abarr et al. discloses an illumination system for a tractor-trailer having a pair of lighting assemblies attached above the rear wheels thereof. A reflector within each light assembly reflects light downward and outward through a lens onto the pavement around the rear wheels. A control circuit is connected to each light source and to the turn signal lead to provide steady power only when the turn signal is enabled. Thus, Abarr et al. provides a reverse assembly operably connected to a turn signal assembly and having lights positioned above the rear wheels. In contrast, the present invention provides a lighting assembly for the rear of a tractor-trailer that illuminates to indicate when the vehicle is in reverse.

These prior art devices have several known drawbacks. Devices in the prior art relate to lighting systems for illuminating the rear of tractor-trailers or other similar vehicles. However, these systems relate to lighting assemblies for illuminating the rear wheels or sides of the vehicle to improve the visibility of the rear of the vehicle. These devices do not disclose rearward facing lights to be positioned on the rear of the trailer of a tractor-trailer that illuminate when the vehicle is shifted into reverse. Further, the devices to not disclose lights that can be remotely controlled by the user.

In light of the devices disclosed in the prior art, it is submitted that the present invention substantially diverges in design elements from the prior art and consequently it is clear that there is a need in the art for an improvement to existing vehicle lighting systems. In this regard the instant invention substantially fulfills these needs.

### SUMMARY OF THE INVENTION

In view of the foregoing disadvantages inherent in the known types of vehicle light systems now present in the prior art, the present invention provides a new reverse light assembly for tractor-trailers wherein the same can be utilized for providing convenience for the user when illuminating the rear of a tractor-trailer when the trailer is in reverse so as to improve visibility for the driver and to alert nearby motorists or pedestrians.

It is therefore an object of the present invention to provide a new and improved vehicle lighting system that has all of the advantages of the prior art and none of the disadvantages.

It is another object of the present invention to provide a vehicle lighting system securable to the rear of the trailer of a tractor-trailer.

Another object of the present invention is to provide a vehicle lighting system adapted to illuminate when a tractor-trailer is placed in reverse.

Yet another object of the present invention is to provide a vehicle lighting system having a control unit that wirelessly communicates with a reverse light assembly such that the user can control the operation of the reverse light assembly while seated in the vehicle.

Another object of the present invention is to provide a vehicle lighting system that automatically illuminates when a vehicle is placed in reverse, wherein the reverse light assembly is operably connected to the reverse lights of the tractor portion of the tractor-trailer.

An additional object of the present invention is to provide a vehicle lighting system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the rear of a tractor-trailer having the reverse light assembly of the present invention installed thereon.

FIG. 2 shows a schematic diagram of the operation of an embodiment of the reverse light assembly of the present invention.

FIG. 3 shows a schematic diagram of the operation of an alternate embodiment of the reverse light assembly of the present invention.

### DETAILED DESCRIPTION OF THE INVENTION

Reference is made herein to the attached drawings. Like reference numerals are used throughout the drawings to depict like or similar elements of the reverse light assembly of the present invention. For the purposes of presenting a brief and clear description of the present invention, the preferred embodiment will be discussed as used for providing lights that illuminate when a tractor-trailer is placed in reverse so as to alert vehicles and persons in the nearby area. The figures are intended for representative purposes only and should not be considered to be limiting in any respect.

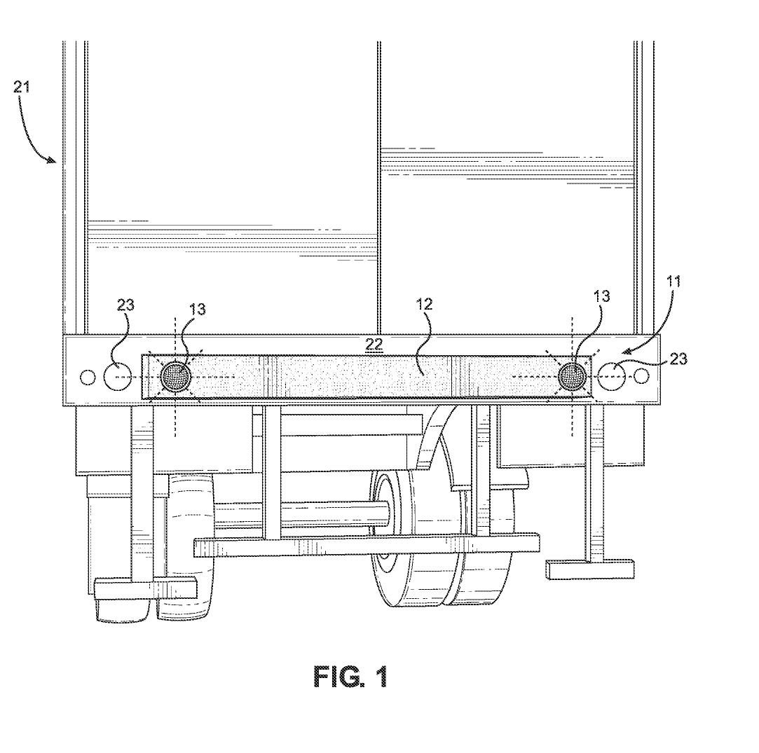

Referring now to FIG. 1, there is shown a perspective view of the rear of a tractor trailer having the reverse light assembly of the present invention installed thereon. The reverse light assembly 11 of the present invention provides reverse lights 13 that are adapted to illuminate when a tractor trailer 21 is in reverse so as to alert other drivers in the nearby area. The reverse light assembly 11 comprises a reverse light housing 12 that encloses one or more lights 13 and the circuitry necessary to operate the lights. Preferably, the housing 12 comprises an elongated rectangular configuration and includes a pair of lights 13 thereon. The lights 13 are arranged on the left and right sides of the housing 12 so that the lights 13 are positioned adjacent to the tail lights and brake lights 23 of the trailer when the housing 12 is mounted to the rear of the trailer 21. When the housing 12 is positioned on the rear of the trailer 21 the lights 13 face outwardly and rearward from the trailer 21. The lights 13 are preferably LED lights so as to be bright and have low power consumption, but the lights 13 may alternatively be incandescent bulbs.

The housing 12 can be permanently or removably mounted to the rear surface 22 of the trailer 21 of a tractor-trailer. The housing 12 can be mounted by means of any suitable fasteners such as a bracket and bolts, nails, or screws, among others. Alternatively, the housing 12 can be magnetically secured to the rear end 22 of the trailer. Preferably, the housing 12 is mounted so that the lights 13 thereon are adjacent to the tail lights 23 on the left and right sides of the trailer 21. The housing 12 is preferably dust tight, oil tight, and water tight. The housing 12 includes a latched cover for providing access to the interior thereof for the purpose of replacing the power source or lights 13 held therein. The housing 12 may include multiple compartments therein such that the lights 13 are physically separated from the circuitry of the housing 12.

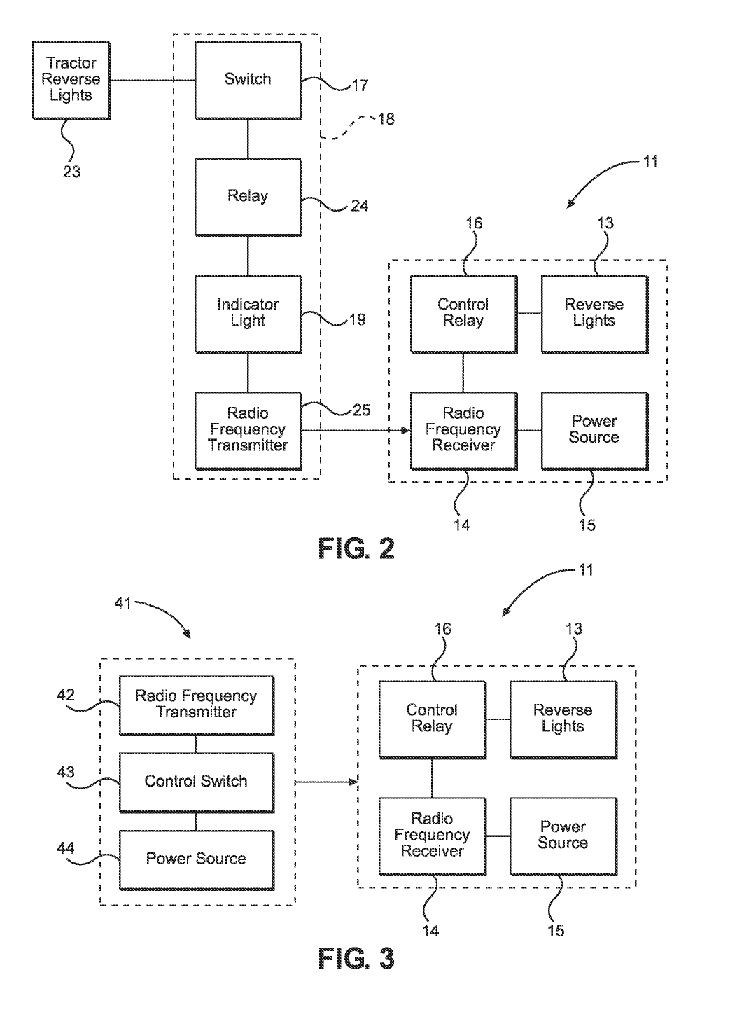

Referring now to FIG. 2, there is shown a schematic diagram of the operation of an embodiment of the reverse light assembly of the present invention. The present invention comprises a control unit 18 and a reverse light assembly 11. The control unit 18 is adapted to detect when the reverse lights of the tractor portion of the tractor-trailer are illuminated and signals the lights 13 of the reverse light assembly 11 to illuminate. The control unit 18 is adapted to be positioned in the cabin of the tractor-trailer and includes a control circuit having a switch 17, an indicator light 19, and a relay 24.

The control unit 18 is adapted to be electrically connected to the existing tractor reverse lights by means of the control circuit. When the tractor is shifted into reverse, the switch 17 closes and the relay 24 is energized. An indicator light 19 disposed on the control unit 18 illuminates when the tractor reverse lights are illuminated, indicating to the driver that power is supplied to the reverse lights on the trailer. The control unit 18 may further include a control switch for disconnecting power to the lights on the trailer. The control unit 18 may include one or more fuses as required to protect the electrical components of the control unit 18 from overvoltage damage, overcurrent damage, or other similar types of electrical failures.

The control unit 18 can be physically connected to the reverse light assembly 11 by means of a wiring harness and trailer junction box. Thus, electrical cables extend from the control unit 18 for connection to the reverse light assembly 11. Alternatively, and as shown in the illustrated embodiment, the control unit 18 may include a radio frequency transmitter 25 adapted to wirelessly communicate with the reverse light assembly 11. The reverse light assembly 11 includes a radio frequency receiver 14 for receiving the signals from the control unit 18. The reverse light assembly 11 further includes a control relay 16 and a power source 15, such as one or more batteries, for powering the lights 13 and other components of the reverse light assembly 11. Once a signal is received by the radio frequency receiver 14, the relay 16 is energized and the lights 13 will illuminate.

Referring now to FIG. 3, there is shown a schematic diagram of the operation of an alternate embodiment of the reverse light assembly of the present invention. In an alternate embodiment, the control unit is replaced with a wireless key fob 41. The key fob 41 includes a radio frequency transmitter 42 for wirelessly sending signals to the reverse light assembly 11. The key fob 41 further includes a power source 44 and a control switch 43 to be operated by the user when the user places the tractor-trailer in reverse. In this way, the user can selectively actuate the control switch 43 in order to send a signal to the reverse light unit 11 in order to illuminate the lights 13 thereon. The reverse light assembly 11 comprises the same construction as in the embodiment shown in FIG. 2, and includes a radio frequency receiver 14, a control relay 16, and reverse lights 13, wherein the components of the reverse light assembly 11 are powered by a power source 15, such as one or more batteries.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A reverse light assembly for a tractor-trailer, comprising:
a reverse light housing comprising an elongated configuration and adapted to be mounted on a rear of a trailer of a tractor-trailer;
one or more lights enclosed within said housing;
a control unit in communication with said one or more lights in said reverse light housing and adapted to cause said one or more lights to illuminate when said tractor-trailer is placed in reverse.

2. The reverse light assembly of claim 1, wherein
said control unit comprises a wireless transmitter;
said reverse light housing comprises a wireless receiver adapted to receive signals from said wireless transmitter;
wherein said one or more lights on said housing are adapted to illuminate when said wireless receiver receives a signal from said wireless transmitter.

3. The reverse light assembly of claim 1, wherein said control unit is electrically connected to reverse lights of a tractor of said tractor trailer such that said one or more lights on said housing illuminate when said reverse lights of said tractor are illuminated.

4. The reverse light assembly of claim 1, wherein said control unit is electrically connected to said reverse light housing.

5. The reverse light assembly of claim 1, wherein said one or more lights are LED lights.

6. The reverse light assembly of claim 1, wherein said reverse light housing comprises a power source adapted to power said one or more lights therein.

7. The reverse light assembly of claim 1, wherein said control unit is adapted to be positioned within a cabin of said tractor trailer.

8. The reverse light assembly of claim 1, wherein
said control unit comprises a key fob having a control switch and a wireless transmitter adapted to send a signal to a wireless receiver of said reverse light housing such that a user can selectively illuminate said one or more lights on said reverse light housing.
